(19) United States
(12) Patent Application Publication
(10) Pub. No.: US 2005/0158021 A1
(43) Pub. Date: Jul. 21, 2005

(54) Recording / reproducing apparatus, and copy method

(75) Inventors: Shogo Sato, Saitama (JP); Satoru Joraku, Saitama (JP)

Correspondence Address: MORGAN LEWIS & BOCKIUS LLP, 1111 PENNSYLVANIA AVENUE NW, WASHINGTON, DC, 20004, US

(73) Assignee: Pioneer corporation

(21) Appl. No.: 11/037,100

(22) Filed: Jan. 19, 2005

(30) Foreign Application Priority Data
Jan. 20, 2004 (JP) 2004-011687

(51) Int. Cl. H04N 5/76; G11B 27/00; G03G 21/00

(52) U.S. Cl. 386/52; 386/55

(57) ABSTRACT

A recording/reproducing apparatus is provided with: a signal extracting device for extracting a reference image signal to display a reference image about contents, at certain time intervals on its reproduction time axis, from an image signal recorded on a magnetic tape; a memory for accumulating the extracted reference image signal; a reading device capable of reading the reference image signal accumulated in the memory, to display the reference image; an inputting device capable of externally inputting an operation instruction about a copy operation from the tape-shaped recording medium to the disc-shaped recording medium, after the reference image is displayed.

### BACKGROUND OF THE INVENTION

1. Field of the Invention

The present invention relates to a copy method of copying information recorded on a tape-shaped recording medium, such as a magnetic tape, onto a disc-shaped recording medium, such as a DVD and a Compact Disc (CD), as well as a recording/reproducing apparatus for performing the copy method.

2. Description of the Related Art

This type of recording/reproducing apparatus can reproduce the information recorded on the magnetic tape and record the information onto the disc-shaped recording medium. The apparatus equipped with both a DVD drive and a video cassette recorder (VCR), can reproduce the content of a videotape and copy it onto a DVD.

In some cases, such an apparatus is used to transfer data recorded on a videotape, to a DVD, for the purpose of storage. In that case, usually, it is desired to copy only necessary contents for data reduction. Which content to copy onto one DVD is to be determined by considering even the capacity of the DVD. In order to do so, at first, it is necessary to learn the content recorded on the videotape and the recording time length. This can be settled by using an operation support function given to the VCR.

For example, Japanese Patent Application Laying Open NO. 2000-261755 describes a technique in which with respect to a videotape on which a plurality of programs are already recorded, a section of a record content is recognized depending on an index signal recorded at the start of recording each program, an index image is prepared for each record content, and a list of the index images is displayed to thereby confirm the record content of the videotape. It further describes a technique in which an index signal position of the recorded program on the videotape is searched for, to cue and reproduce, in selecting the desired recorded program on the basis of the displayed list of index images. Moreover, Japanese Patent Application Laying Open NO. 2003-32582 describes a technique of displaying a list of contents information for each contents, such as a still picture and character information.

### SUMMARY OF THE INVENTION

However, the above-described techniques rather have a prior condition which is reproduction of the tape content, and there is room for improvement from the viewpoint of operationality in copying.

The technique in Japanese Patent Application Laying Open NO. 2000-261755 does not support the case where it is desired to confirm the content only in the latter part of the videotape, or similar cases, because the technique is intended to prepare the index images by searching the videotape as a whole. In this case, the index image associated with the content in the former part of the videotape is rather unnecessary, and an image preparation time length becomes long by that much. Moreover, in preparation of the index image, as described above, the index signal already recorded on the videotape is used. However, the content copied from a camcorder (single-unit camera video recorder) or the like to the videotape does not have a section in many cases, and in this case, there is a possibility of improper operation of the apparatus. In addition, if a plurality of contents recorded on one videotape are copied onto the DVD or the like, desired contents are individually to be cued on the basis of the list display, and copied one by one, so that it takes time and labor for operation. Moreover, the copy is mostly performed by manual operation, so that there is possibly such a failure that an operator carelessly forgets to cue, to thereby copy partially.

In the technique in Japanese Patent Application Laying Open NO. 2003-32582, the record content is merely presented, and it is difficult to reduce the labor and time for the copy, as described above.

It is therefore an object of the present invention to provide a recording/reproducing apparatus which can perform a well operational copy operation an efficient copy operation, as well as a copy method.

(Recording/Reproducing Apparatus)

The above objects of the present invention can be achieved by a recording/reproducing apparatus provided with: a tape reproducing device capable of reproducing a contents signal including an image signal recorded on a tape-shaped recording medium; a disc recording device capable of recording the contents signal onto a disc-shaped recording medium; a signal extracting device for extracting a reference image signal to display a reference image about contents, from the image signal recorded on the tape-shaped recording medium; a memory for accumulating the extracted reference image signal; a reading device capable of reading the reference image signal accumulated in the memory, to display the reference image; an inputting device capable of externally inputting an operation instruction about a copy operation from the tape-shaped recording medium to the disc-shaped recording medium, after the reference image signal is read from the memory by the reading device; and a controlling device for controlling the tape reproducing device and the disc recording device in accordance with the operation instruction about the copy operation inputted to the inputting device.

According to the recording/reproducing apparatus of the present invention, in copying from the tape-shaped recording medium to the disc-shaped recording medium, at first, the image signal recorded on the tape-shaped recording medium is sampled, and the reference image signal is extracted and accumulated in the memory. The reference image signals accumulated in the memory are read, step by step or collectively, and on the basis of these reference signals, the reference image is displayed. A user confirms the record content of the tape-shaped recording medium by using the displayed reference image, and then, gives the final instruction about the copy operation.

The “operation instruction about the copy operation” herein indicates an instruction of an operation related to the copy. Specifically, an instruction of whether or not to perform the copy operation, an instruction of whether or not to specify the copy range, and the specification of operation conditions, such as the setting of the copy range, correspond to this operation instruction. Incidentally, the copy range may be set on the basis of the reference image.

On the recording/reproducing apparatus, at first, information about the user's decision-making is provided to the user by displaying an image which can be a copy object. The user determines a next operation in accordance with the information, and inputs an instruction for indicating that, from the inputting device. As descried above, by confirming the content of the tape-shaped recording medium in conjunction with the operation instruction about the copy, it is possible to operate in accordance with the user's desire, to thereby improve user-friendliness.

In one aspect of the recording/reproducing apparatus of the present invention, the inputting device can further specify, by external input, whether or not display of the reference image, which is based on the reference image signal read from the memory, is required, and if it is specified by the inputting device that the display of the reference image is required, the signal extracting device extracts the reference image signal, and the controlling device controls operations of the tape reproducing device and the disc recording device, in accordance with the operation instruction about the copy operation inputted on the inputting device, and if it is specified by the inputting device that the display of the reference image is not required, the signal extracting device does not extract the reference image signal, and the controlling device controls the tape reproducing device and the disc recording device, so as to perform the copy operation regardless of the reference image.

According to this aspect, the reference image is displayed depending on the use's judgment about whether or not the display is required. If it is specified that the display of the reference image is required, the reference image is displayed by a series of operations described above. Then, on the basis of the reference image, the operation instruction about the copy operation is performed by the user's judgment, and further, the operation control corresponding to this instruction is performed. On the other hand, if it is specified that the display of the reference image is not required, the operations associated with the display of the reference image are not performed, and the copy range is also determined regardless of the reference image. As described above, by proceeding the setting of the conditions with asking the user's judgment, it is possible to copy in accordance with the user's will.

In another aspect of the recording/reproducing apparatus of the present invention, the inputting device can specify, by external input, whether display of the reference image is performed (i) after a part of the image signal at a current reproduction position on tape reproducing device, or (ii) after a beginning of the image signal, and if it is specified by the inputting device that the display of the reference image is performed after the part of the image signal, the signal extracting device extracts the reference image signal after the part of the image signal, and if it is specified by the inputting device that the display of the reference image is performed after the beginning of the image signal, the signal extracting device extracts the reference image signal after the beginning of the image signal.

The current reproduction position on the tape reproducing device is, in addition to the beginning of the tape-shaped recording medium, halfway of the tape-shaped recording medium in some cases. The current reproduction position may be in any one of the above cases, however, specifically in the latter case, by specifying, with the inputting device, that the display of the reference image is performed (i) after the part of the image signal at the current reproduction position, it is possible to confirm only the content after the current reproduction position. Namely, for example, as in the case where tape-shaped recording medium is left with the former part recorded, if the user knows the record content before the current reproduction position in advance and the confirmation of the content is not required, it is possible to display the reference image in a range precisely matched with the user's desire. Moreover, the limitation of the display range causes reduction of a time length for the preparation of the reference image and reduction of the number of the reference images displayed, so that it is possible to provide more comfortable environment for use.

On the other hand, by specifying, with the inputting device, that the display of the reference image is performed (ii) after the beginning of the image signal, it is possible to confirm the content after the beginning of the tape-shaped recording medium, regardless of whether the current reproduction position on the tape reproducing device is the beginning or halfway of the tape-shaped recording medium. As described above, the user can set the range by himself in which the content is confirmed, so that it is possible to realize an excellent user interface.

In another aspect of the recording/reproducing apparatus of the present invention, the signal extracting device extracts the reference image signal such that the reference image is a thumbnail image.

According to this aspect, the reference image is displayed as the thumbnail image, and the user can overview the content of the tape-shaped recording medium.

In another aspect of the recording/reproducing apparatus of the present invention, the signal extracting device extracts the reference image signal such that the reference image for each logical unit of the contents signal is displayed.

According to this aspect, the reference image is displayed for each logical unit, such as contents, which makes it easier for the user to know the content.

In another aspect of the recording/reproducing apparatus of the present invention, the inputting device can externally input whether or not the copy operation is required, as the operation instruction about the copy operation.

According to this aspect, the user can confirm the content of the tape-shaped recording medium and examine whether or not to copy the content. Then, the user instructs whether or not the copy operation is required. Thus, it is possible to copy in accordance with the user's will.

In another aspect of the recording/reproducing apparatus of the present invention, the inputting device can specify a performance range of the copy operation, by external input based on display of the reference image, as the operation instruction about the copy operation.

According to this aspect, the user can set the copy range after confirming the content of the tape-shaped recording medium. Namely, by performing one copy operation, a plurality of contents can be selectively transferred to the disc-shaped recording medium, which is extremely useful. Moreover, the copy range can be set easily and certainly, by specifying it on the basis of the reference image.

(Copy Method)

The above objects of the present invention can be also achieved by a copy method in a recording/reproducing apparatus provided with: a tape reproducing device capable of reproducing a contents signal including an image signal recorded on a tape-shaped recording medium; a disc recording device capable of recording the contents signal onto a disc-shaped recording medium; a memory; and an inputting device capable of externally inputting an operation instruction about a copy operation of the contents signal from the tape-shaped recording medium to the disc-shaped recording medium, the copy method provided with: an extracting process of extracting the reference image signal to display the reference image about contents, from the image signal recorded on the tape-shaped recording medium; an accumulating process of accumulating the extracted reference image signal in the memory; a reading process of reading the reference image signal accumulated in the memory, to display the reference image; an external inputting process of externally inputting the operation instruction about the copy operation by using the inputting device, on the basis of the reference image displayed on the basis of the read reference image signal; and a performing process of performing an operation corresponding to the externally inputted operation instruction.

The copy method of the present invention performs the same action and has the same effect as in the above-described recording/reproducing apparatus of the present invention.

Incidentally, the copy method of the present invention may take various aspects, corresponding to various aspects of the recording/reproducing apparatus of the invention.

As explained above, according to the recording/reproducing apparatus of the present invention, it is provided with: the signal extracting device; the memory; the reading device; the inputting device; and the controlling device, so that it is possible to perform the well operational operation and efficient copy operation, well operationally.

As explained above, according to the copy method of the present invention, it includes: the extracting process of extracting the reference image signal; the accumulating process of accumulating the signal in the memory; the reading process of the reading the signal to display the reference image; the inputting process of inputting the operation instruction about the copy operation on the basis of the reference image displayed; and the performing process of performing the operation about the copy, so that it is possible to perform the well operational operation and efficient copy operation, well operationally.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram showing the structure of a recording/reproducing apparatus in an embodiment of the present invention;

FIG. 2 is a flowchart (1) showing a copy method in the embodiment of the present invention;

FIG. 3 is a flowchart (2) showing the copy method in the embodiment of the present invention;

FIG. 4 is a flowchart (3) showing the copy method in the embodiment of the present invention;

FIG. 5 is a schematic diagram shown to explain operations before the copy of the recording/reproducing apparatus shown in FIG. 1;

FIG. 6 is a schematic diagram shown to explain a sampling operation of sampling reference image signals, out of the operations in FIG. 5;

FIG. 7 is a schematic diagram showing data accumulated in a memory in response to the sampling operation in FIG. 6;

FIG. 8 is a schematic diagram showing a reference screen in the embodiment of the present invention; and

FIG. 9 is a schematic diagram shown to explain a copy operation in the embodiment of the present invention.

### DETAILED DESCRIPTION OF THE PREFERRED EMBODIMENT

An embodiment of the present invention will be hereinafter explained with reference to the accompanying drawings.

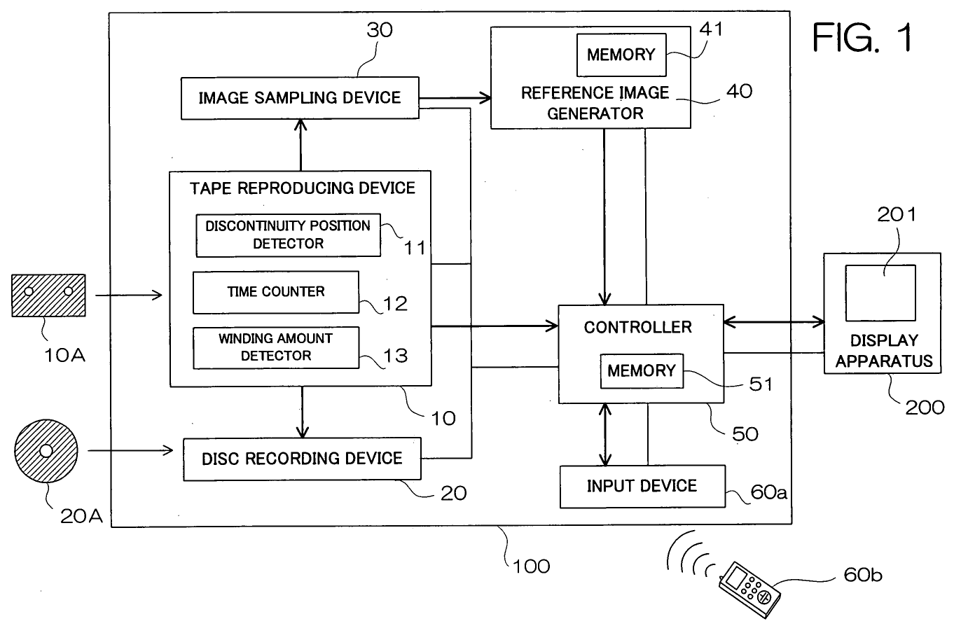

FIG. 1 shows the structure of a main part of a recording/reproducing apparatus in the embodiment. This recording/reproducing apparatus 100 is provided with: a tape reproducing device 10; a disc recording device 20; an image sampling device 30; a reference image generator 40; and a controller 50. A videotape 10A and an optical disc 20A can be inserted into the recording/reproducing apparatus 100, and the record content of the videotape 10A can be copied onto the optical disc 20A. Incidentally, in FIG. 1, a thin line between the controller 50 and each constituent element indicates a control line for transmitting and receiving a control signal. A thick line between the constituent elements indicates a data line for exchanging data. The recording/reproducing apparatus 100 is connected to a display apparatus 200 with a cable or the like.

The tape reproducing device 10 has a function of reproducing an analog image signal and an analog audio signal from the videotape 10A and converting them to a digital signal. The tape reproducing device 10 includes: a discontinuity position detector 11; a time counter 12; and a winding amount detector 13. The discontinuity position detector 11 is constructed to detect a discontinuity portion in a reproduction signal. The time counter 12 is constructed to measure or count a time, in conjunction with a winding operation, in reproduction of the videotape 10A. The winding amount detector 13 is constructed to detect the winding amount of the videotape 10A to specify a current tape reproduction position.

The disc recording device 20 has a function of writing the inputted image signal and the inputted audio signal onto the optical disc 20A.

The image sampling device 30 is constructed to extract a reference image signal corresponding to a still picture from the image signal reproduced on the tape reproducing device 10, at certain time intervals on a reproduction time axis. Specifically, on the basis of the count time at the time counter 12, one frame of the image signal is sampled with the passage of a certain time length, and transmitted to the reference image generator 40. By this, the reference image signals are extracted at certain intervals on the reproduction time axis, regardless of the recording density or reproduction speed of the videotape 10A, such as a normal recording mode, a long-time (low quality) recording mode, and a high quality mode.

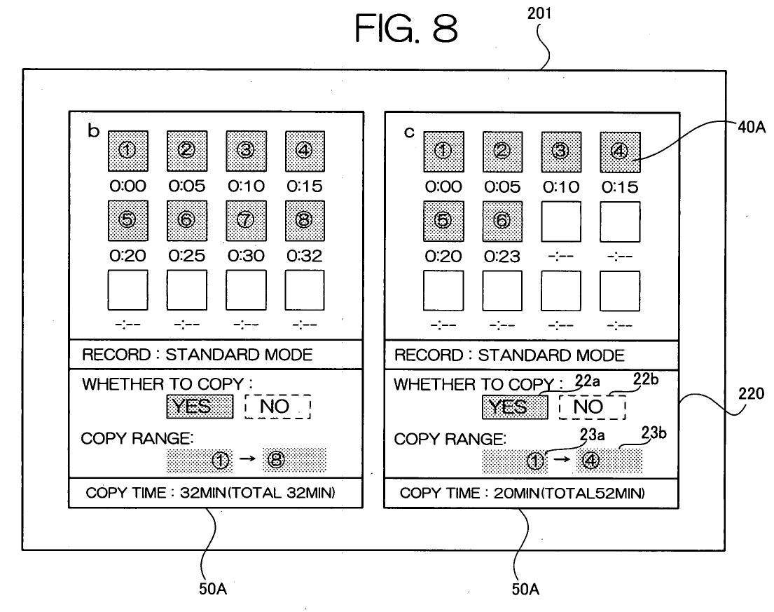

The reference image generator 40 functions to generate thumbnail images 40A (refer to FIG. 8) on the basis of the reference image signals inputted from the image sampling device 30. The reference image generator 40 further functions to accumulate the thumbnail images 40A in a memory 41. Incidentally, each thumbnail image 40A is generally a low quality still picture, however, it may be a moving picture associated with a short reproduction time length.

The controller 50 is provided to control each operation of the tape reproducing device 10, the disc recording device 20, the image sampling device 30, and the reference image generator 40. Thus, the controller 50 is connected to each of these constituent elements with the control line, as described above.

Moreover, the controller 50 is constructed to receive various information about the videotape 10A from the tape reproducing device 10, and accumulate it in a memory 51. As the received information, a copy start position and a discontinuity position of the videotape 10A, the reproduction time length and the recording mode of the contents corresponding to the thumbnail images, and the like are listed. The signal position of the video tape 10A and the reproduction time length are expressed on the basis of the count time of the time counter 12.

Moreover, the controller 50 is constructed to receive the thumbnail images 40A from the memory 41 of the reference image generator 40, and output them to the display apparatus 200 to display them at a predetermined position on a screen, in combination with the information about the reproduction time length accumulated in the memory 51. Namely, the thumbnail images 40A represent the outline of the videotape 10A, and a user can learn the record content of the videotape 10A by overviewing the display.

Input devices 60a and 60b are provided to externally input various settings or the like, with respect to the recording/reproducing apparatus 100. The input device 60a is, for example, a display panel and buttons mounted in a unified manner on the recording/reproducing apparatus 100. The input device 60b is remote control equipment which a user can operate in his hand. A not-illustrated receiver of the input device 60a receives a radio signal transmitted from the input device 60b.

The display apparatus 200 can externally receive the image signal, and is provided with: a not-illustrated controller; a not-illustrated drive circuit; and a display screen 201 for displaying on the basis of the received image signal. In order to externally input the instruction associated with the recording/reproducing apparatus 100 (or various settings to the display apparatus 200 or the recording/reproducing apparatus 100), there is a touch panel 220 having a Graphical User Interface (GUI), on the display screen 201 (refer to FIG. 8). The inputted instruction (or the inputted settings) in the GUI of the display apparatus 200 are transmitted, as the control signal, from the controller of the display apparatus 200 to the controller 50 of the recording/reproducing apparatus 100. The controller 50 performs control about a copy operation as explained later, on the basis of the control signal received from the display apparatus 200.

<Copy Operation of Recording/Reproducing Apparatus>

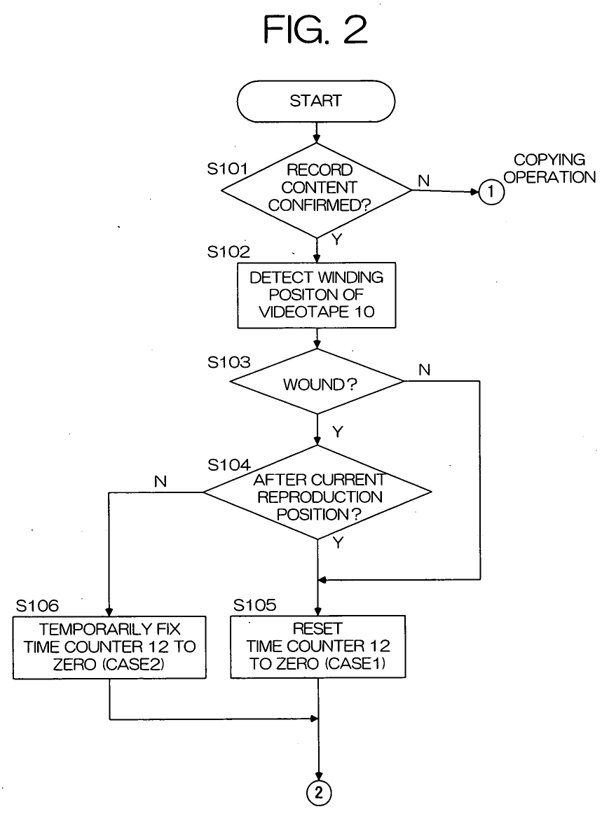

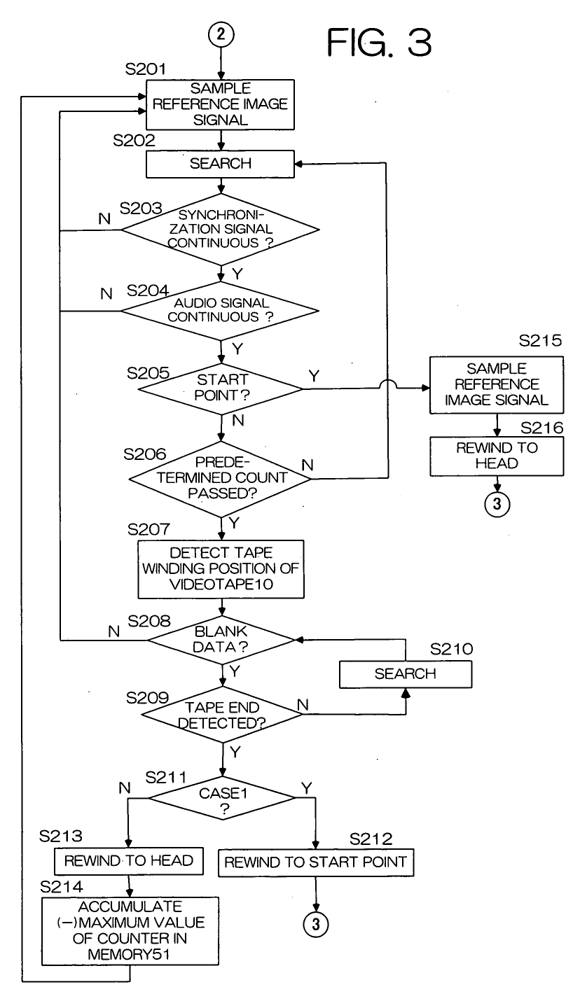

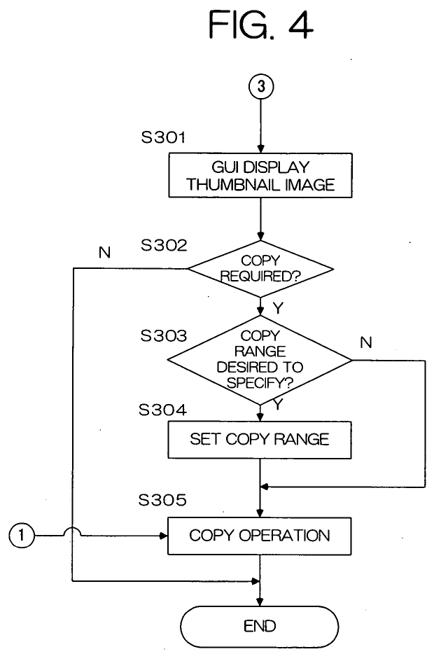

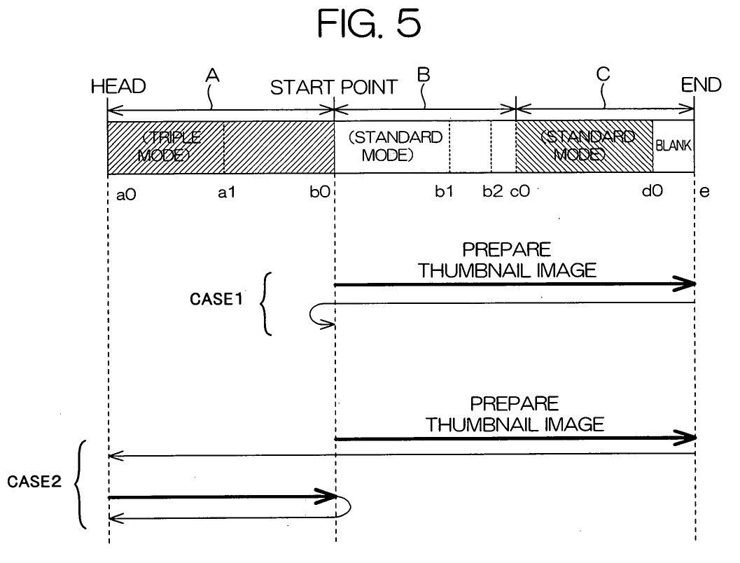

Next, operations in copying from the videotape 10A to the optical disc 20A in the recording/reproducing apparatus 100 will be explained with reference to FIG. 1 to FIG. 9. Incidentally, FIG. 2 to FIG. 4 are a series of flowcharts, showing the copy operation. FIG. 5 to FIG. 9 are schematic diagrams to explain operations as being a pretreatment of the copy operation.

When the videotape 10A is set on the tape reproducing device 10, the optical disc 20A is set on the disc recording device 20, and a copy mode is selected, the setting of a copy range of the videotape 10A, as described later, is performed under the control of the controller 50.

In the flowcharts of FIG. 2 to FIG. 4, at first, it is selected by a user whether to confirm the record content of the videotape 10A (step S101). Such selection is performed by operating the input device 60a or 60b, or a device, such as the GUI, on the touch panel 220.

Then, if the confirmation of the record content is unnecessary, such as the case where the user already knows the content of the videotape 10A (the step S101: N), the control signal for indicating that is inputted from the GUI or the like to the controller 50, and the controller 50 starts the copy operation (step S305).

On the other hand, if the confirmation of the record content is performed (the step S101: Y), the thumbnail image 40A (refer to FIG. 8) for indicating the record content is generated and displayed in the following manner.

At first, the videotape 10A is reproduced on the tape reproducing device 10 so that the winding amount detector 13 detects the winding amount. From the detected winding amount, the current reproduction position of the videotape 10A is found (step S102).

At this time, if the videotape 10A is not wound and can be reproduced almost from the beginning (the step S103: N), the controller 50 resets the time counter 12 to zero (step S105), and starts to prepare the thumbnail images 40A, with respect to the image signals after the beginning (head) of the videotape 10A.

However, if the videotape 10A is wounded partially (step S103: Y), the user is asked about whether or not the record content to confirm here is the content after the current reproduction position (step S104). This is also performed by operating the input device 60a or 60b, or the GUI or the like on the touch panel 220. In this condition in which the videotape 10A is wounded partially, there may be the following cases: one is the case where cueing is performed in advance in accordance with the content to copy; and the other is the case where the videotape 10A happens to be stored in this condition. As is the former, if this condition is set by the user with his sufficient knowledge of the content of the videotape 10A, the reproduction position in this condition may be regarded as the copy start position. However, in the latter case, it is conceivable that the user does not intend to do so and is about to start copying without noticing that the videotape 10A is wound partially. In fact, in such a condition, there are many cases that the user realizes later that he has copied only partially and starts to copy all over again.

Thus, in the embodiment, the user is informed that the videotape 10A is wound partially and asked about the display range of the record content. If it is all right that the range of the content confirmation is after the current reproduction position, the user inputs an instruction for indicating that, from the GUI or the like (step S104: Y). The controller 50 uses this inputted instruction as a trigger to reset the time counter 12 to zero (step S105), and starts to prepare the thumbnail images 40A, with respect to the image signals after the current reproduction position of the videotape 10A.

The case where the content confirmation and the copy range selection are performed after the current reproduction position of the videotape 10A as described above is referred to as a case 1.

On the other hand, if the user replies No to this inquiry (the step S104: N), the controller 50 temporarily fixes the time counter 12 to zero (step S106), and starts to prepare the thumbnail images 40A, with respect to the image signals after the head of the videotape 10A. Incidentally, the case where the content confirmation and the copy range selection are performed with respect to the whole videotape 10A, regardless of the current reproduction position in the above manner, is referred to as a case 2.

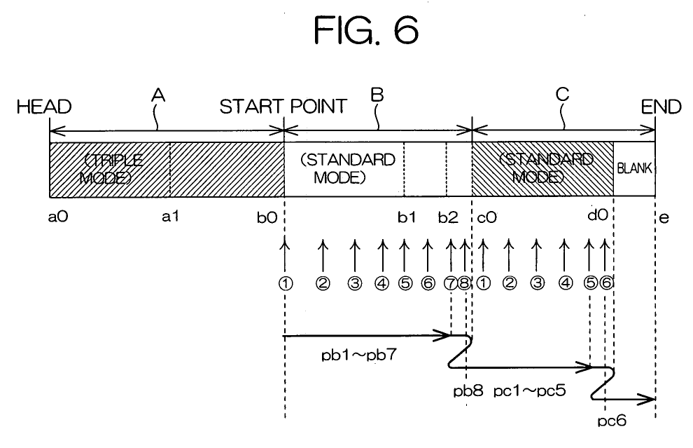

Then, as shown in FIG. 5 and FIG. 6, in any of the case 1 and the case 2, the thumbnail images 40A are prepared in a range from the current reproduction position to the end.

FIG. 5 schematically shows each operation in the case 1 and the case 2. Moreover, FIG. 6 shows the details of the sampling operation of sampling the reference image signals, required to prepare the thumbnail images 40A. Here, on the videotape 10A, there are three types of contents A, B, C, recorded with a camcorder and copied from respective master tapes. Namely, positions a0, b0, and c0 are boundaries of each contents, where RF signals are discontinuous. At positions a1, b1, and b2, RF signals are discontinuous on respective master tapes, but the copy is performed continuously onto this videotape. There is blank data after a point d0, which indicates that nothing is recorded. It is assumed that the videotape 10A is set on the tape reproducing device 10 with it wound partially, and that the current reproduction position, i.e. a start point, is b0.

Incidentally, the case 1 includes that the start point is the head of the tape. The operations in that case may be equivalent to the operations, with the start point replaced, in the case where the start point is halfway of the tape. Thus, the case where the start point is halfway of the tape, as shown in FIG. 5, will be explained below.

At first, at the start point b0, a reference image signal for one screen is taken into the image sampling device 30 (step S201). This is, as shown in FIG. 6, an image signal at a first sampling point pb1, out of the RF signals corresponding to the contents B.

The reference image signal is processed to the thumbnail image 40A on the reference image generator 40, for example, and accumulated in the memory 41. Moreover, the controller 50 obtains count data of the time counter 12 at this time, and stores it into the memory 51 in association with the generated thumbnail image 40A. The above operations are performed at each time of sampling the reference image signal, for example.

Then, the videotape 10A is fast-forwarded and searched (step S202). The fast-forwarding operation is performed for a certain time length on the reproduction time axis, e.g., until 5 minutes passes by using the count time of the time counter 12 herein, as long as a synchronization signal and an audio signal are continuous (step S203: Y, step S204: Y), and as long as the current reproduction position is not back at the start point again by rewinding or the like (step S205: N).

Then, when 5 minutes passes by using the count time of the time counter 12 (step S206: Y), the winding position of the videotape 10A at that time is detected by the winding amount detector 13 (step S207) and the videotape 10A is reproduced. If there is still a RF signal to be reproduced (step S208: N), this reproduction position is regarded as a sampling point pb2, and a reference image signal is sampled (the step S201). As descried above, the reference image signal taken into the image sampling device 30 is processed to the thumbnail image 40A on the reference image generator 40, and accumulated in the memory 41. The count time of the time counter 12 at the sampling point pb2 is accumulated in the memory 51 in association with the thumbnail image 40A generated at this time. In this manner, the sampling of a reference image signal, the search, and the reproduction are repeated at sampling points pb2, pb3, pb7. As a result, the thumbnail images 40A are generated every 5 minutes, with respect to most of the contents B.

Then, the search is started from the sampling point pb7. If the position c0 where the synchronization signal is discontinuous is detected by the discontinuity position detector 11 before 5 minutes passes by using the time counter 12 (step S203: N), the videotape 10A is rewound a little and the last part of the contents B is regarded as a sampling point pb8, and a reference image signal is sampled immediately before the point c0 (the step S201). On the basis of this signal, the last thumbnail image 40A of the contents B is generated.

In reaching to the point c0, since the synchronization signal is discontinuous (the step S203: N), this reproduction position is regarded as a sampling point pc1, and a reference image signal is sampled. Then, the sampling of a reference image signal, the search, and the reproduction are repeated at sampling points pc2, pc3, . . . , pc5. Then, when the point d0 is detected, the videotape 10A is rewound a little. The last part of the contents C is regarded as a sampling point pc6, and a reference image signal is sampled. As a result, even with respect to the contents C, the thumbnail images 40A are generated every 5 minutes, except the last part.

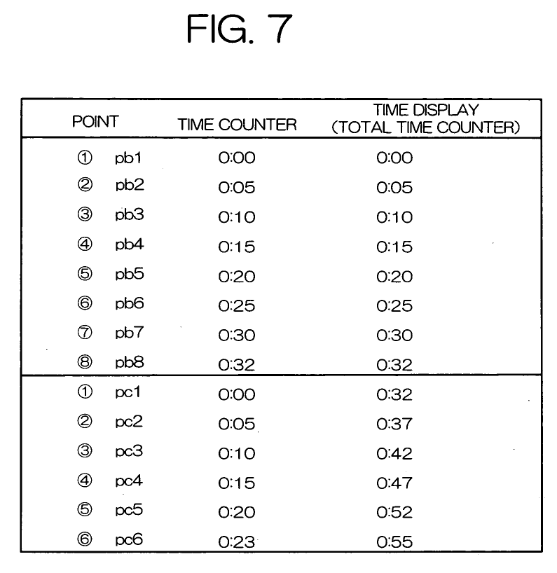

Then, if the blank data after the point d0 is reproduced (the step S208: Y) until the end of the videotape 10A is detected (step S2809: N), the search and the reproduction are repeated (step S210). However, a reference signal image is not sampled. By the above operations, in the memory 51 of the controller 50, as shown in FIG. 7, the count time of the time counter 12 and the total time length are recorded as a table, correspondingly to each sampling point.

Then, if the winding amount detector 13 detects the end of the videotape 10A (step S209: Y), different operations are performed in the case 1 and case 2 respectively.

Namely, in the case 1 (step S211: N), as shown in FIG. 5, the videotape 10A is rewound to the start point b0 (step S212). The controller 50 generates a reference screens 50A based on a series of thumbnail images 40A accumulated in the memory 41 and the time data accumulated in the memory 51 corresponding to a series of thumbnail images, and transmits them to the display apparatus 200. On the display apparatus 200, the reference screen 50A is displayed on the display screen 201 (step S301).

The reference screens 50A are displayed for each contents, for example, as shown in FIG. 8, and the thumbnail images 40A and the count times are arranged in a time series on each reference screen 50A. Here, by displaying 5-minute interval pictures as thumbnail images, the user can substantially learn the content of the contents. Moreover, as other information, the type of the recording mode, such as a standard mode and a triple mode, is displayed. Moreover, these reference screens 50A can display the inquiry about whether or not it is necessary to copy the contents, and this instruction of the necessity or unnecessity can be externally inputted by GUIs 22a and 22b. Moreover, display devices 23a and 23b are provided to specify the copy range, even in the contents. Into the display portions 23a and 23b, the reproduction range corresponding to the thumbnail images 40A can be inputted. As a device for that purpose, a GUI may be provided fro one portion of each thumbnail image 40A. Alternatively, the display apparatus 200 main body or the remote control equipment thereof may be operated with their buttons, to select and input a number corresponding to each thumbnail image 40A.

FIG. 8 shows the case where the instruction of “copying” is selected by the GUI 22a (step S302: Y), with respect to both the contents B and C. Moreover, in the contents B, as shown on its display portions 23a and 23b, a range of the first to the eighth of the thumbnail images 40A is selected as the copy object (step S303: Y, step S304). In other words, in the contents B, from the sampling point pb1 to immediately before the sampling point pc1, i.e. whose reproduction time length is 32 minutes, is the copy object. With respect to the contents C, a range of the first to the fourth of the thumbnail images 40A is selected as the copy object. Namely, from the sampling point pc1 to immediately before the sampling point pc5, i.e. whose reproduction time length is 20 minutes, is the copy object.

Here, the copy time length of the range selected in this manner, and the total of the copy time length for each contents are displayed on the reference screen 50A. A copy source in the case 1 is the whole contents B and the range from the beginning of the contents C to the fourth thumbnail image 40A, i.e. the range of the sampling points pb1 to pc 5. Thus, a time length required for the copy is 52 minutes in total. By checking this before the copy, the user can confirm whether or not the data in the selected range can be stored on the optical disc 20A.

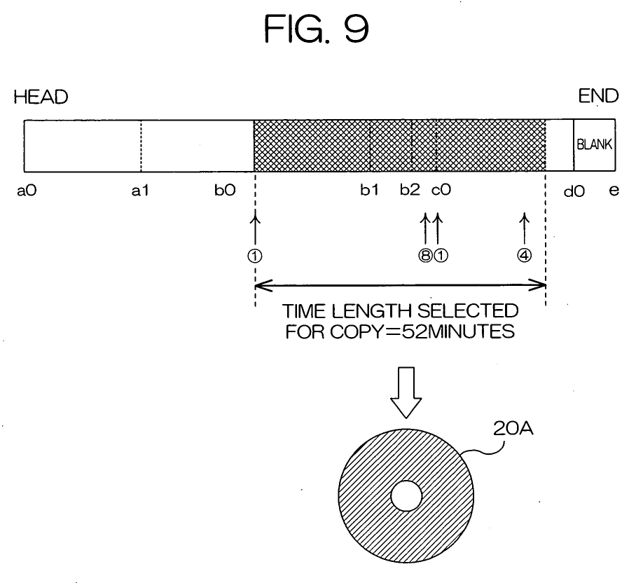

By referring to the reference screens 50A, the user overviews the record content of the contents B and C, and sets whether or not to copy (step S302). If the copy is performed (the step S302: Y), and further if it is desired to specify the copy range (the step S303: Y), the copy range is set by using the displayed thumbnail images 40A (the step S304). If the copy range is set on the display screen 201 in this manner, information about the determination of the copy range is transmitted to the controller 50. As shown in FIG. 9, the controller 50 performs the copy operation on the basis of the information about the copy range, received from the display apparatus 200 (the step S305). In this manner, the user can select the copy range by using the thumbnail images 40A, in addition to confirming the content of the videotape 10A before the copy.

Incidentally, if the instruction of “not copying” is selected by the GUI 22b (the step S302: N), the operations about the copy are ended. Namely, the user can stop the operations about the copy after looking at the content display. Moreover, even if the instruction of copying is selected, if nothing is inputted to the display portions 23a and 23b, the controller 50 judges that there is no desire to specify the copy range (the step S303: N), and the whole record content of the videotape 10A is copied without distinction (the step S305). In this case, the user can give a final instruction of starting to copy, after confirming the content of the videotape 10A.

On the other hand, in the case 2 (the step S211: Y), as shown in FIG. 5, the videotape 10A is rewound to the head (step S213). At that time, the time counter 12 takes a minus value, however, the maximum value of the absolute value is accumulated in the memory 51. Then, from the head of the videotape 10A, reference image signals are sampled every 5 minutes on the reproduction time axis, in the same manner (the step S201). Then, in reaching to the start point b0 (the step 205: Y), the videotape 10A is rewound a little, and a reference image signal is sampled from the last part of the contents A (step S215). As a result, even for the contents A, the thumbnail images 40A are generated. Then, the videotape 10A is rewound to the head (step S216).

Then, the controller 50 generates the reference screens 50A, 50B, and 50C with respect to the contents A, B, and C, respectively, and transmits them to the display apparatus 200. On the display apparatus 200, the reference screens 50A, 50B, and 50C are displayed (the step S301). Therefore, after overviewing the record content of the contents A, B, and C, the user can specify whether or not it is necessary to copy (the step S302), specify the copy range (the step S303), and further set the copy range by using the displayed thumbnail images 40A (the step S304).

In the case 2, as described above, initially, the videotape 10A is wounded partially. However, only by the user's instruction, the recording/reproducing apparatus 100 automatically generates and displays the reference screens (i.e. the reference screens 50A, 50B, and 50C) with respect to the whole contents in the videotape 10A. Thus, while the recording/reproducing apparatus 100 performs a series of operations associated with the preparation of the reference screens 50A, 50B, and 50C, the user has no necessary to operate and monitor the apparatus.

Incidentally, the contents B and C are in the standard mode, while the contents A is recorded in the triple mode. However, the reference image signals are sampled, not depending on the index signal, but on the basis of the count time of time counter 12, so that even if there are the contents in different recording modes, the sampling intervals of the thumbnail images 40A, which are extracted from the videotape 10A, are equal.

If the copy range is set by the user in this manner (the step S304), the copy operation is performed (the step S305).

As described above, the recording/reproducing apparatus 100 in the embodiment is constructed to confirm the winding position of the videotape 10A, to ask the user about the subsequent operation, and to confirm the content of the videotape 10A in combination with the setting of the copy conditions on the reference screen 50A, thereby to help the user's decision-making about the copy and to help the operation setting of the apparatus. Thus, it is possible to reduce the complexity of the operations and mistakes in the operations, which improves user-friendliness. Moreover, by using the GUIs 22a and 22b and the display portions 23a and 23b, a plurality of contents can be selectively transferred to the optical disc 20A, which allows the efficient copy operation.

Moreover, the image signals are sampled at certain time intervals on the time counter 12, so that even if there are the contents in different recording modes, the thumbnail images 40A are displayed at the certain time intervals. Thus, the user can learn the content of the magnetic tape, easily and appropriately.

Moreover, the reference image signals are sampled regardless of the index signal, so that the thumbnail images can be generated regardless of the presence or absence of the index signal.

Incidentally, a function of automatically setting the recording mode of the optical disc 20A may be provided for the above-explained recording/reproducing apparatus 100. If the user selects the automatic setting mode, the recording mode is automatically selected by the controller 50 such that a copy source can be included in one optical disc 20A and that the quality is as high as possible. Taking the case 1 as an example, the time length required for the copy is 52 minutes in total, i.e. just under 60 minutes, as shown in FIG. 9. Thus, the recording mode of the optical disc 20A is set to a one hour mode. Incidentally, it is possible to relatively reduce the capacity of the memory 41 by deleting the stored content of the memory 41 after shifting to the copy operation.

Incidentally, in the present invention, it is enough if the final operation about the copy can be set after the reference screen is displayed. There can be various modifications in timing, content, and a manner of inquiry, such as whether or not to display the reference screen (i.e. the thumbnail images), which range of the image signals is used to display the reference screens, and whether or not to perform the copy operation itself or the copy range specification in the final operation setting. For example, even if it is unnecessary to confirm the record content (the step S101: N), it may be constructed to detect the winding position of the videotape 10A. If the winding position is halfway, it may be constructed to ask the user about whether to copy after the head of the videotape 10A or from the halfway position without doing anything, to thereby select what to do, or it may be constructed to set in advance in the apparatus.

Moreover, in the embodiment, at the time point when the winding position of the videotape 10A is found out, the operation is divided into two types in the case 1 and in the case 2. However, if the winding position of the videotape 10A is halfway, it may be constructed, firstly, to display the thumbnail images 40A after the reproduction position, and secondly, to ask whether or not to display the thumbnail images 40A after the beginning of the videotape 10A.

Alternatively, if the winding position of the videotape 10A is halfway, it is also possible to add, as the option for the subsequent operation, the case where the copy range is selected in a range of the head of the videotape 10A to the current reproduction position, in addition to the case 1 (i.e., the copy range is selected after the current reproduction position) and the case 2 (i.e., the copy range is selected after the head of the videotape 10A). For example, a videotape that is left as it is after recorded has the wound part which is already recorded, and may have the latter part which is blank. Considering such a case, it may be enough if only the record content before the current reproduction position is confirmed.

Moreover, in the embodiment, the section of the contents recorded on the videotape 10A is detected by whether or not the RF signal is discontinuous. Except that, it may be also detected by using a change in the audio signal, such as a monaural mode, a stereo mode, and a bilingual mode, using a VHS Index Search System (VISS) signal included in the recorded video signal, or using similar signals.

Moreover, in the embodiment, as shown in FIG. 8, the thumbnail images 40A and the information about the contents are displayed on the same screen, as the operation screen for setting whether or not it is necessary to copy and the like. However, a screen for displaying the thumbnail images may be provided aside from the operation screen for performing the setting about the copy. For example, after the screen for display is displayed, the screen may be changed to the operation screen by the operation of the user side.

Moreover, in the recording/reproducing apparatus 100, a still picture is taken as the reference image signal, and the thumbnail image 40A is displayed as the still picture. However, images for certain time length, such as 10 seconds in the reproduction time length, may be taken as the reference image signal, and each thumbnail image may be displayed with a moving picture or by the frame advance of still pictures. The audio signal may be taken as well as the reference image signal, to thereby output audio in conjunction with the thumbnail images 40A. Moreover, in the embodiment, the recording mode is displayed in addition to the thumbnail images 40A and the reproduction time length. However, other information may be displayed to help the user know or recognize the contents. For example, if the contents signal of the videotape includes a title of the contents and other information, those information may be displayed on the reference screens 50A, 50B, and 50C.

Furthermore, in the embodiment, in sampling the reference image signal, the blank part of the videotape 10A is searched until the end of the tape. However, if a condition without any RF signal keeps for more than a certain time length, the search may be ended at that time point, and the videotape may be rewound.

Incidentally, the signals can be transmitted and received, not only by cable connection, but also wireless LAN or the like, between the recording/reproducing apparatus 100 and the display apparatus 200. The recording/reproducing apparatus 100 and the display apparatus 200 may be constructed in one body.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-011687 filed on Jan. 20, 2004 including the specification, claims, drawings and summary is incorporated herein by reference in its entirety.

1. A recording/reproducing apparatus comprising:
a tape reproducing device capable of reproducing a contents signal including an image signal recorded on a tape-shaped recording medium;
a disc recording device capable of recording the contents signal onto a disc-shaped recording medium;
a signal extracting device for extracting a reference image signal to display a reference image about contents, from the image signal recorded on said tape-shaped recording medium;
a memory for accumulating the extracted reference image signal;
a reading device capable of reading the reference image signal accumulated in said memory, to display the reference image;
an inputting device capable of externally inputting an operation instruction about a copy operation from said tape-shaped recording medium to said disc-shaped recording medium, after the reference image signal is read from said memory by said reading device; and
a controlling device for controlling said tape reproducing device and said disc recording device in accordance with the operation instruction about the copy operation inputted to said inputting device.

2. The recording/reproducing apparatus according to claim 1, wherein
said inputting device can further specify, by external input, whether or not display of the reference image, which is based on the reference image signal read from said memory, is required, and
if it is specified by said inputting device that the display of the reference image is required, said signal extracting device extracts the reference image signal, and said controlling device controls operations of said tape reproducing device and said disc recording device, in accordance with the operation instruction about the copy operation inputted on said inputting device, and
if it is specified by said inputting device that the display of the reference image is not required, said signal extracting device does not extract the reference image signal, and said controlling device controls said tape reproducing device and said disc recording device, so as to perform the copy operation regardless of the reference image.

3. The recording/reproducing apparatus according to claim 1, wherein
said inputting device can specify, by external input, whether display of the reference image is performed (i) after a part of the image signal at a current reproduction position on tape reproducing device, or (ii) after a beginning of the image signal, and
if it is specified by said inputting device that the display of the reference image is performed after the part of the image signal, said signal extracting device extracts the reference image signal after the part of the image signal, and
if it is specified by said inputting device that the display of the reference image is performed after the beginning of the image signal, said signal extracting device extracts the reference image signal after the beginning of the image signal.

4. The recording/reproducing apparatus according to claim 1, wherein said signal extracting device extracts the reference image signal such that the reference image is a thumbnail image.

5. The recording/reproducing apparatus according to claim 1, wherein said signal extracting device extracts the reference image signal such that the reference image for each logical unit of the contents signal is displayed.

6. The recording/reproducing apparatus according to claim 1, wherein said inputting device can externally input whether or not the copy operation is required, as the operation instruction about the copy operation.

7. The recording/reproducing apparatus according to claim 1, wherein said inputting device can specify a performance range of the copy operation, by external input based on display of the reference image, as the operation instruction about the copy operation.

8. A copy method in a recording/reproducing apparatus comprising: a tape reproducing device capable of reproducing a contents signal including an image signal recorded on a tape-shaped recording medium; a disc recording device capable of recording the contents signal onto a disc-shaped recording medium; a memory; and an inputting device capable of externally inputting an operation instruction about a copy operation of the contents signal from said tape-shaped recording medium to said disc-shaped recording medium,
said copy method comprising:
an extracting process of extracting the reference image signal to display the reference image about contents, from the image signal recorded on said tape-shaped recording medium;
an accumulating process of accumulating the extracted reference image signal in said memory;
a reading process of reading the reference image signal accumulated in said memory, to display the reference image;
an external inputting process of externally inputting the operation instruction about the copy operation by using said inputting device, on the basis of the reference image displayed on the basis of the read reference image signal; and
a performing process of performing an operation corresponding to the externally inputted operation instruction.
